(19) United States
(12) Patent Application Publication
(10) Pub. No.: US 2009/0270115 A1
(43) Pub. Date: Oct. 29, 2009

(54) Receipt Notification of Asynhronous Messages

(76) Inventors: Arnaud Brun, Boulogne Billancourt (FR); Celine Rouviere, Chaleins (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/083,454

(22) PCT Filed: Oct. 9, 2006
(86) PCT No.: PCT/FR2006/051003

§ 371 Date: Oct. 31, 2008

(30) Foreign Application Priority Data
Oct. 10, 2005 (FR) 0510313

(51) Int. Cl. H04W 4/14

(52) U.S. Cl. 455/466

(57) ABSTRACT

A method and a system for personalized notification of reception of a message, comprising a step of composing an MMS message on a first terminal (1) and a step of sending the MMS message to a second terminal (3). Before the step of sending the MMS message, the first terminal (1) inserts a page containing a notification element in said MMS message. Upon reception of the message by the second terminal (3), reception thereof is notified by means of the notification element inserted in the message.

### FIELD OF THE INVENTION

The present invention relates to the field of messages exchanged asynchronously between terminals, such as MMS messages exchanged between mobile telephones. The invention is more particularly concerned how reception of such messages is notified on the terminal of the recipient.

### PRIOR ART

At present, when the (mobile or fixed) terminal of a user receives an MMS multimedia or other type message (e.g. an SMS message), it informs the user of the reception of the message so that they can read it. To this end, several behaviors of the terminal are possible, depending on the functions available on the user terminal that receives the message and on the configuration that the user has chosen. The functions available at present on commercially-available terminals include:
ringing and/or vibration of the terminal (the ringtone can vary according to the number of the sender of the message);
displaying an icon on the screen of the terminal;
displaying a text (e.g. “New Message”) on the screen of the terminal;
displaying the number of the sender of the message on the screen of the terminal; and/or
displaying the name and/or the photo/image corresponding to the number of the sender of the message stored in the directory of the terminal.

In all cases, it is the user of the receiver terminal who defines, locally in the terminal, how the terminal is to notify reception of a new message, depending on the functions offered by the terminal.

At present there is no solution for enabling the sender of the (MMS, SMS or other) message, as opposed to its recipient, to define how reception of the message that is being sent is to be notified.

Document WO 2004/056073 describes a system in which the sender of a mobile telephone call can notify the call by sending a notification message to the called user. However, the system described in the above document applies exclusively to notifying synchronous services such as telephone calls. It cannot be used to personalize notification of reception of MMS or SMS messages, which rely on asynchronous services. The system described in the document WO 2004/056073 is relatively complex and requires considerable modification to the hardware of existing telecommunication systems. This complexity is explained in particular by the fact that an aim of the system described is to notify synchronous services, which implies that notification messages are sent virtually simultaneously with calls.

### OBJECT AND SUMMARY OF THE INVENTION

An object of the present invention is to alleviate those drawbacks by proposing a solution enabling senders of messages to define themselves how reception of a message is to be notified on the terminal of the recipient of the message.

This object is achieved by a message reception notification method, comprising a step of composing an MMS message on a first terminal and a step of sending the MMS message to a second terminal, the method being characterized in that it further comprises, before the step of sending said MMS message, a step of the first terminal inserting a page (SLn) containing a notification element (ENn) in said MMS message and, after the step of sending said message, a step of notifying reception of said MMS message on the second terminal by means of the notification element inserted in the message.

Accordingly, by inserting a notification element into the message sent, the sender of the message can choose how the arrival of the message is to be notified on the terminal of the recipient. The solution provided by the present invention, when a user wishes to send an interpersonal message, consists in enriching the content of the message. The message sent therefore contains both the “payload” portion of the message (the information that the user wishes to send) and the portion containing the multimedia elements that the receiver terminal uses to notify its user of the arrival of the message.

According to one aspect of the invention, the method comprises, before the step of inserting the notification element (ENn) in the message, a step of the first terminal forming the notification element by selecting or creating one or more multimedia elements. The sender can personalize notification of a message from a wide selection of multimedia elements.

The method of the invention further comprises, before the step of sending the MMS message, a step of adding a notification field to the header (MMS-H) of the MMS message, reception of said MMS message on the second terminal by means of the notification element being notified as a function of the value of the field added to the header of the message. This step is transparent to the user and indicates on reception of the message the presence of a page (SLn) to be processed in a particular manner to activate a notification element in the message.

The method of the invention can further comprise a step of the MMS center interrogating the second terminal to verify the capacity of said terminal to notify reception of the message by means of the notification element (ENn) inserted in the message and a step of the MMS center eliminating the notification element in the MMS message in the event of verification giving a negative result. In this way, the notification element is sent only if it can be used by the receiver terminal.

The invention also applies to other types of messages such as SMS messages. Under such circumstances, the body of the MMS message includes an element corresponding to the text of the SMS message.

The present invention also provides a message reception notification system including terminals between which MMS messages are exchanged via an MMS center, the system being characterized in that the terminals include means for inserting a notification element (ENn) in an MMS message and means for notifying reception of said message on a receiver terminal using the notification element sent with the MMS message.

Like the method described above, the system of the invention provides the sender of a message with a solution enabling the sender to define how the reception of a message is to be notified on the terminal of the recipient.

The terminals further include means for adding a notification field to the header of the MMS message and means for detecting the notification field on reception of the message, reception of said MMS message being notified on the receiver terminal by means of the notification element (ENn) as a function of the value of the field added to the header of the message.

According to one aspect of the invention, the MMS center includes means for verifying the capacity of the receiver terminal to notify reception of the message by means of the notification element (ENn) inserted in the MMS message and means for eliminating the notification element in the MMS message in the event of verification giving a negative result.

The present invention further provides an MMS client program adapted to be installed in a terminal, the program comprising instructions for composing, sending, and receiving MMS messages and being characterized in that it further comprises instructions for inserting a notification element (ENn) in an MMS message. The program further comprises instructions for notifying reception of an MMS message on the terminal using the notification element (ENn) sent with the MMS message. The program further comprises instructions for automatically adding a notification field in the header (MMS-H) of the MMS message and for notifying its arrival as a function of the value of the notification field.

This kind of MMS client, once loaded into a terminal, offers its user tools for personalizing the way in which the reception of messages that it sends are notified, and for notifying the reception of messages that it receives with the notification element included therein.

Finally, the invention also provides a mobile or fixed terminal including an MMS client program as described above.

### BRIEF DESCRIPTION OF THE DRAWINGS

The features and advantages of the present invention emerge more clearly from the following description, which is given by way of indicative and non-limiting example and with reference to the appended drawings, in which:

FIG. 1 is a diagrammatic view of a network architecture in which a system and a method of the invention for notifying reception of messages are implemented;

FIG. 2 shows the structure of an MMS multimedia message;

FIG. 3 is a flowchart of an implementation of a method of the invention for sending a message with a personalized notification element;

FIG. 4 is a flowchart showing the steps executed by the invention to send from the terminal of the sender an MMS message with personalized notification;

FIG. 5 is a flowchart showing the steps executed by the invention when the terminal of the recipient receives an MMS message with personalized notification;

FIG. 6 is a flowchart showing the steps executed by an MMS center of the invention when sending the terminal of the recipient an MMS message with personalized notification.

### DETAILED DESCRIPTION OF EMBODIMENTS OF THE INVENTION

The present invention proposes a solution for a user sending a message to define how reception of the message is notified on the terminal of the recipient. To this end, the invention uses the known MMS (Multimedia Messaging Service) technology. For simplicity, most of the elements used in the present invention and using that technology are distinguished by the term MMS (e.g. MMS message).

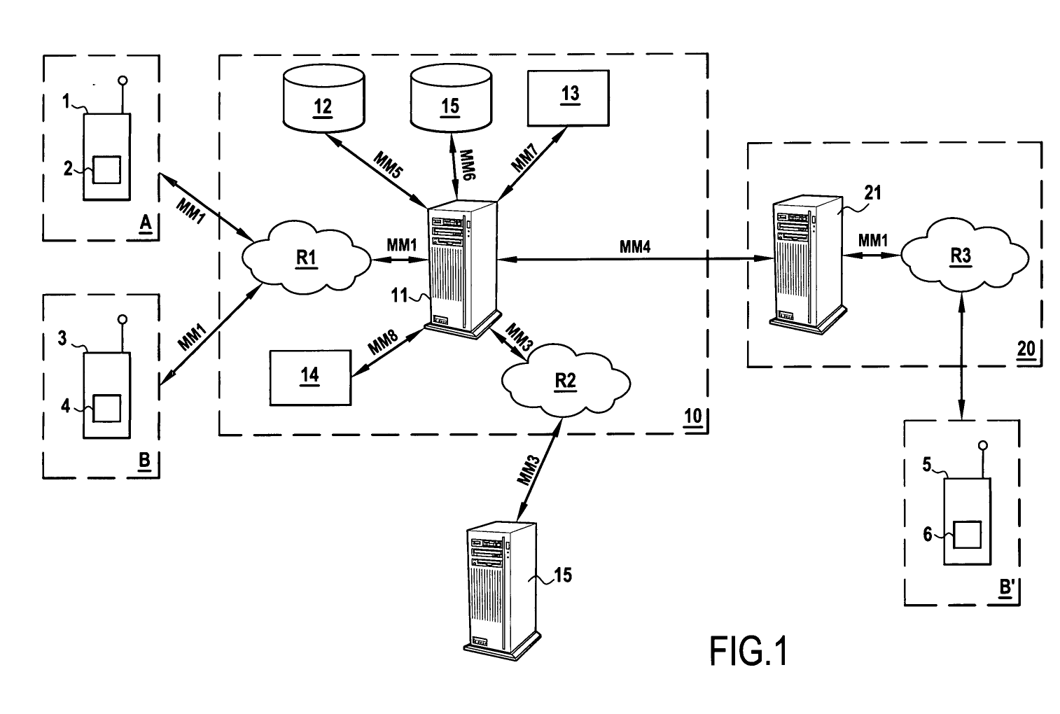

FIG. 1 shows the architecture of a system for exchanging MMS messages in which the invention can be used. This known architecture comprises an MMS environment 10 for exchanging MMS messages between a terminal 1 of a user A and a terminal 3 of a user B both connected to a mobile telephone network R1 (e.g. a GSM, GPRS or UMTS network). In the description below, user A is considered to be the sender of the message and user B the recipient of the message.

The MMS environment (MMSE) 10 comprises an MMS center (MMSC) 11 that manages routing of MMS messages in the MMS environment 10 as well as to other environments 20 or other messaging services 15. The MMS center 11 is also responsible for storing messages awaiting delivery to a terminal in this environment. The routing (MMS relay) function and the storage (MMS server) function can be implemented by separate equipments or integrated into the same equipment, as in the MMS center 11 of the FIG. 1 system. That known MMS center essentially consists of one or more servers comprising software modules for processing (e.g. routing, storing, adapting) MMS messages.

The MMS center 11 is also connected to value-added services (VAS applications) 13, a database 12 for managing users and their location (Home Location Register (HLR)), billing systems 14, and databases 15 holding information on MMS users (e.g. presence information). Another function of the MMS center is to adapt MMS messages as a function of the capacities of the receiver terminal. Before downloading a message to the receiver terminal, the MMS center interrogates the receiver terminal to identify its capacities (e.g. screen size, image resolution, etc.) and where appropriate to adapt the content of the message as a function of the capacities so identified. The content is adapted by the MMS center using an adaptation module in the form of software programmed in the MMS center.

The network elements under the control of a multimedia messaging service provider (MMS content provider) enable access to MMS services by subscribing users of a telecommunication network (e.g. the network R1 in FIG. 1). Thus the MMS environment 10 comprises a network infrastructure adapted to transport, adapt, and store MMS messages and software for composing, sending, and receiving MMS messages, at terminal level as well as at network level.

The entities of a system for exchanging MMS messages communicate via dedicated interfaces, namely:
an interface MM1 for exchanges between an MMS client in a terminal and an MMS center;
an interface MM2 between the routing (MMS relay) and storage (MMS server) entities of the MMS center; most supplier solutions integrate both these entities into the same equipment, and so this interface is a proprietary (i.e. non-standardized) interface;
an interface MM3 that enables an MMS center to exchange messages with other messaging servers (e.g. the server 15 from FIG. 1 accessible via an Internet-type network R2);
an interface MM4 that handles exchange of MMS messages between two MMS centers of two different MMS environments (e.g. MMS centers 11 and 21 of the FIG. 1 system);
an interface MM5 that enables the MMS center to interrogate the user management database (e.g. the database 12 in FIG. 1);
an interface MM6 that enables the MMS center to access information on MMS users in the database (e.g. the database 15 in FIG. 1);
an interface MM7 that transfers MMS messages from an MMS center to value-added services (e.g. services 13 in FIG. 1), and vice-versa;
an interface MM8 that enables the MMS center to interact with billing systems (e.g. the system 14 in FIG. 1).

The mobile terminals 1 and 3 adapted to exchange MMS messages via the MMS environment 10 must be equipped with an MMS client 2, respectively 4 installed in the terminal. The MMS client (or MMS User Agent (MMS-UA)) is user application software installed on the terminal to enable composition, presentation, sending, and reception of MMS messages. The MMS clients 2 and 4 are attached to a corresponding MMS environment, here the MMS environment 10, corresponding to the network R1 (e.g. a GSM, GPRS or UMTS network) to which the sender and receiver terminal subscribes.

As shown in FIG. 1, the environment of the sender or receiver can be different for a user B′ attached to another environment 20 corresponding to another subscriber network R3. Under such circumstances, the terminal 5 of the user B′ contains an MMS client 6 adapted to the MMS environment 20. Just like the MMS environment 10 described above, the MMS environment 20 comprises an MMS center 21 and all the other network elements (not shown) necessary for managing MMS messages, as already described for the MMS environment 10.

The MMS message exchange system architecture of FIG. 1 is well known in itself and is not described in more detail so as not to overcomplicate the present description unnecessarily. Nevertheless, among others, the following documents published by the 3GPP standardization organization for third generation mobile systems (www.3gpp.org) can be usefully consulted.

It must be possible to integrate personalization of notification of reception of messages in accordance with the present invention into existing MMS environments. To this end, as described in detail below, a specific field is added to MMS messages which, as a function of its value, enables particular processing of a page corresponding to the notification (SLn) contained in the message and activation of notification on the terminal of the recipient as defined by the sender of the message.

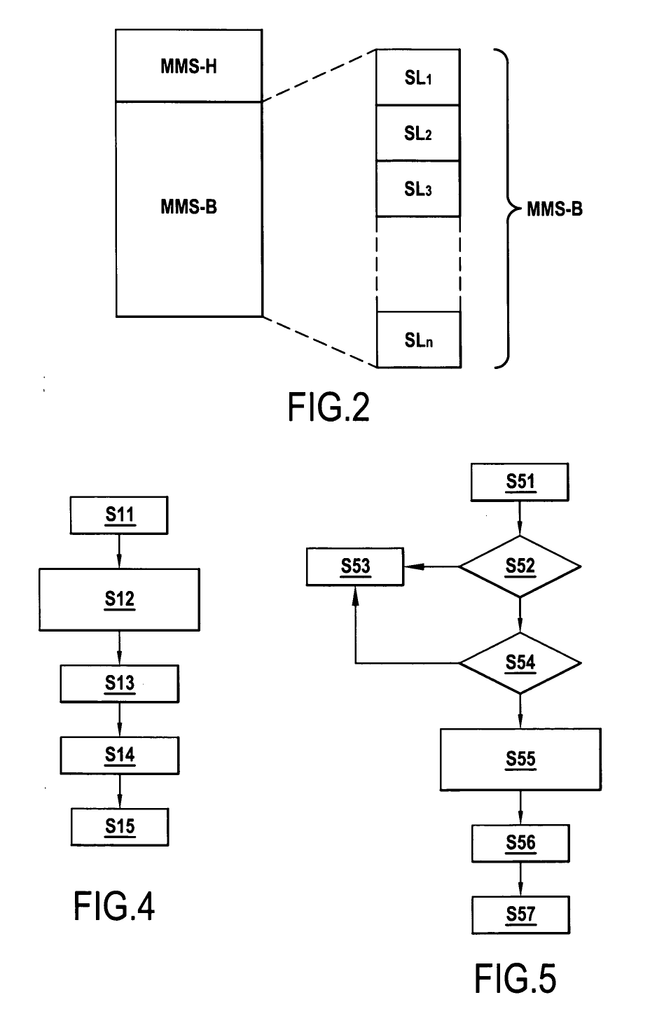

In the known manner shown in FIG. 2, an MMS message includes a header MMS-H and a body MMS-B. The header MMS-H of the MMS message contains information relating to transporting the message, for example identifiers of the recipient and the sender and information relating to the message sent (date of sending, message validity date, subject of message, etc.). Information from the MMS header is organized according to fields to which values are assigned.

The message body MMS-B can contain one or more pages SL1 to SLn, usually called “slides”. In a message, the pages (“slides”) are generally defined in the standardized Synchronized Multimedia Integration Language (SMIL), which synchronizes various elements contained in the message. Where appropriate, these “slides” can be defined in a language specific to the terminal.

Each of the pages SL1 to SLn of the body of an MMS message contains one or more multimedia elements, such as a sound, an image, a text, etc. Consequently, the body of an MMS message is made up of a succession on pages SL1 to SLn each containing one or more multimedia documents (sound, image, text, etc.), the nature of each of those documents being determined by an identifier.

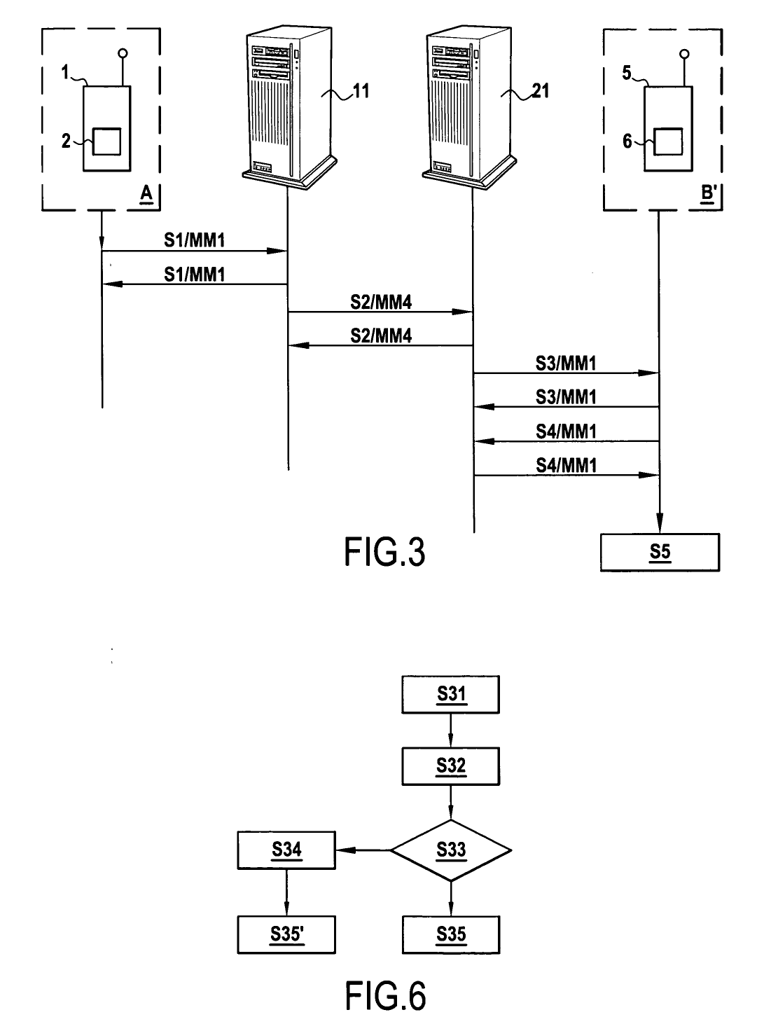

With reference FIG. 3, there follows a description of an example of use of the method of the invention of sending a message with personalization, by the sender, of how reception of the message is notified on the terminal of the recipient. In this example, the user A from FIG. 1 sends an MMS message to the user B′.

The first step (step S1) is to compose and send an MMS message.

To be more precise, and as shown in FIG. 4, the user A composes in the ordinary way on a terminal an MMS message M1 for sending to a user B′ (step S11). For the user this operation consists in entering the address of the user who is to receive the message and editing the multimedia elements that are to be sent with the message.

The user A then defines how the terminal 5 of the recipient B′ is to notify reception of this message M1 to its user. For this, it is possible to select one or more multimedia elements ENn to constitute the notification element of the invention (step S12). Such elements can be selected from the following, for example:
a ringtone (or more generally any audio clip) to be played by the terminal B′;
a photo/image or an avatar to be displayed on the screen of the terminal B′,
a video or an animation to be played by the terminal B′;
a text to be displayed on the screen of the terminal B′.

These multimedia elements can either be already available locally in the terminal A or generated directly by the user A when creating the MMS message M1 (e.g. using the terminal to create and store a sound or a photo).

After selecting these multimedia elements, when the user A wishes to send the message (i.e. by pressing the “Send” button, for example), the MMS client 2 of the terminal A adds (transparently for the user) a new page (new “slide”) to the MMS message M1 corresponding to the notification, and then inserts the multimedia element or elements chosen by the user for personalizing notification of reception of the message (step S13). The MMS client 2 adds a notification field in the header of the message whose function is described in more detail below (step S14).

The MMS client 2 then sends the MMS message M1 composed in this way to the MMS center 11 with which it is associated (step S15). In practice, the exchange of the MMS message M1 between the MMS client 2 and the MMS center 11 corresponds to a request to submit a message M1 from the terminal 1 to the center 11 and an acknowledgement of reception of that request.

In the example considered, the MMS environment 20 of the user B′ is different from the environment 10 of the user A. The MMS center 11 of the MMS environment 10 then sends the MMS message M1 to the MMS center 21 of the MMS environment 20, which acknowledges reception (step S2). The MMS center 21 notifies the MMS client 6 of the user B′ that a message M1 is available for it (step S3). The MMS client 6 downloads the MMS message M1 to the terminal 5 (step S4). The MMS client 6 notifies the user B′ of the arrival of the new MMS message M1 (step S5) using the notification element inserted into the message M1 by the user A during the step S1 described above (i.e. steps S11 to S15 in FIG. 4).

FIG. 5 shows the processing steps performed by the MMS client 6 of the terminal 5 to notify reception of the MMS message M1. When the MMS message M1 has been received by the terminal 5 (step S51), the MMS client 6 determines if the notification field is present in the header of the message (step S52). If not, the MMS message M1 is treated as a standard MMS message (step 53). If a notification field is present in the header of the MMS message M1, the MMS client 6 verifies the value assigned to that field (step S54). If the value indicates that there is no page containing notification elements in the message (e.g. if the “Notification-Mode” field=0), the MMS message M1 is treated as a standard MMS message (step S53). Otherwise, if the value of the field indicates that a page SLn containing one or more notification elements ENn is present in the message (e.g. if the “Notification-Mode” field=1), the MMS client 6 recovers the notification element or elements ENn contained in the page (step S55) and notifies reception of the message to the user B′ in a personalized way using the recovered element or elements ENn (step S56). Finally, the MMS client plays the MMS message in the conventional way (step S57).

To enable processing of the notification element by the MMS client 4 of the terminal B receiving the message, the invention proposes to add to the header of MMS messages a new Boolean-type “Notification-Mode” field. To ensure backward compatibility with current MMS equipment (MMS terminals, MMS-center servers), this notification field is conditional. It is present only if the receiving terminal supports the function of the present invention, as explained below.

This new notification field needs to be present in the transactions defined in the MMS standards (3GPP standards TS 22.140: Multimedia Messaging Service (MMS), stage 1 and TS 23.140: Multimedia Messaging Service (MMS), stage 2). It needs to be present at the interfaces MM1 (the standard interface between the terminal and the MMS center), MM4 (the standard interface between two MMS centers), and MM7 (the standard interface between content providers and the MMS center) (see FIG. 1).

According to the present invention, to be able to act on the notification element, the MMS client of a terminal must be able to detect the “Notification-Mode” notification field and execute the necessary actions in response to the value of that field. If the “Notification-Mode” notification field is absent from the transaction, the MMS message must be processed in the standard manner. There is then no modification of the behavior of the receiver terminal.

If the “Notification-Mode” field is present in the transaction, it can take only the value 0 or 1. The table below summarizes the actions to be executed by the MMS client in the receiver terminal as a function of the value of the “Notification-Mode” notification field:

| “Notification- | |
|---|---|
| mode” field | Processing required in terminal receiving |
| value | message |
| 0 | “Standard” MMS message: receiver terminal |
| | must notify reception of message in |
| | standard manner, i.e. as defined by its |
| | user. |
| 1 | MMS message of which one page (“slide”) SLn |
| | (see FIG. 2) contains information |
| | necessary for notification of its reception |
| | on receiver terminal. |
| | The receiver terminal must then: |
| | extract the multimedia elements |
| | contained in said page SLn of the received |
| | message; |
| | use those multimedia elements to |
| | notify the user of the arrival of the |
| | message; |
| | not play back the page SLn |
| | containing the notification element when |
| | the message is played back to the |
| | recipient. |

The notification element can correspond to the last page of the body of the message. This convention is defined in exactly the same way in all the MMS clients of the terminals to enable them systematically to find the notification element in the received MMS message. However, the MMS clients of the present invention are not restricted to this convention and can have parameters set in accordance with a convention which defines that the notification element is the first page of the body of an MMS message or some other page. In the remainder of the description, it is considered that the notification element corresponds to the last page of the body of an MMS message.

To avoid taking up room unnecessarily in the memory of the receiver terminal, the received MMS message M1 is stored in the memory of the terminal without its notification element, here the last page.

According to one aspect of the invention, the function for notifying the reception of a message on the terminal of the recipient according to a notification element defined in the terminal of the sender can be activated or deactivated either from the terminal of the sender of the message or from that of the recipient of the message. Users activate/deactivate this function by setting parameters of the MMS client of their terminals.

If the user A sending a message has activated this function, user A can either define a mode of notifying the reception of messages that is to be used for all messages sent, or a different notification mode for each message composed.

If the user B receiving a message has activated this function, the reception of a message is notified using multimedia elements determined by the user A (using the method described above). Otherwise, if the user B has deactivated this function, reception of a message is notified in the standard way, i.e. according to notification parameters configured on the terminal of the user B.

The method and the system of the present invention can be applied to sending MMS messages as described above and also, more generally, to sending any type of message and in particular SMS (“Short Message Service”) messages.

In the particular circumstance of sending an SMS message, the sending terminal of the user A sends an MMS message whose body includes two pages (two “slides”):
a first page SL1 containing the text of the SMS message that the sender wishes to send;
a second page SL2 containing the information necessary for notifying its reception on the receiver terminal.

The processing carried out in the receiver terminal of the user B is exactly the same as when sending an MMS message. To be more precise, on receiving the MMS message, the MMS client of the receiving terminal detects the notification field and notes that its value indicates that the last page SL2 contains a notification element. It then notifies the arrival of the message to the user B by processing the last page SL2 of the body of the message (notification element) in the terminal. Then, when the user B requests to read the message, it processes (i.e. displays) the first page SL1 of the message in the standard way for reading an MMS message, this element corresponding to the SMS message.

If the receiving terminal does not support the function, the MMS center can be programmed to eliminate the last page (“slide”) corresponding to the notification element, so as to leave the body of the MMS message with only its own content. To this end, a new rule is added to the content adaptation module of the MMS center.

FIG. 6 shows the processing steps carried out by an MMS center when it sends an MMS message to the receiver terminal (e.g. during step S3 in FIG. 3). When the MMS center receives the MMS message to be forwarded to the receiving terminal (step S31), it interrogates the receiving terminal before downloading the MMS message in order to receive the identity of the terminal (step S32). From the received identity of the terminal, the MMS center determines if the receiver terminal is compatible with the personalized notification function (step S33). If not, the MMS center eliminates from the header of the message the “Notification-Mode” notification field and the page SLn containing the notification element or elements ENn (step S34), the message modified in this way then being downloaded to the terminal of the recipient (step S35′). If the receiver terminal supports the personalized notification function, the message is downloaded to the terminal of the recipient as it stands (i.e. with the notification field and the page containing the notification element(s)) (step S35).

The present invention has been described with reference to systems for exchanging MMS messages including mobile terminals. However, these systems can also include fixed terminals adapted to send and receive MMS messages. To this end, it suffices for the fixed terminal to be equipped with an MMS client similar to that installed in mobile terminals.

Consequently, the present invention introduces new functions into personalizing notification of reception of messages without this entailing major modification of existing MMS message exchange systems. The modifications required are entirely in software and consist primarily in adapting the MMS clients (e.g. by adding plug-ins), the processing modules of the MMS centers, such as the adaptation module (e.g. by adding new rules), and at least the standard interfaces MM1, MM4, and MM7 to send the notification field present in the message header.

Example of an MMS message header containing the Notification-Mode field at the interface MM1:

Date: Mon, 3 Oct. 2005 16:29:45 +0100 (MET)

From: 0612345678

Message-Id: <200202041529@mmsc-service.com>

X-Mms-Message-Type: m-send-req

X-Mms-Transaction-ID: 612278480

X-Mms-Version: 1.0

To: 0601020304

Subject: News !!!

X-Mms-Message-Class: personal

X-Mms-Expiry: 1050938985

X-Mms-Priority: normal

X-Mms-Delivery-Report: no

X-Mms-Read-Reply: no

Notification-Mode: 1

1. A message reception notification method comprising:
a step of composing an MMS message on a first terminal;
a step of sending the MMS message to a second terminal; and
before the step of sending said MMS message, a step of the first terminal inserting a page containing a notification element in said MMS message and, after the step of sending said message, a step of notifying reception of said MMS message on the second terminal by means of the notification element inserted in the message.

2. The method according to claim 1, further comprising, before the step of inserting the notification element in the message, a step of forming the notification element by selecting or creating one or more multimedia elements from the first terminal.

3. The method according to claim 1, further comprising before the step of sending the MMS message, a step of adding a notification field to the header of the MMS message, reception of said MMS message on the second terminal by means of the notification element being notified as a function of the value of the field added to the header of the message.

4. The method according to claim 1, wherein the MMS message sent by the first terminal to the second terminal passes in transit through an MMS center and the method further comprises a step of the MMS center interrogating the second terminal to verify the capacity of said terminal to notify reception of the message by means of the notification element inserted in the message and a step of the MMS center eliminating the notification element in the MMS message in the event of verification giving a negative result.

5. The method according to claim 1, wherein the body of the MMS message comprises an element corresponding to an SMS message.

6. A message reception notification system including terminals between which MMS messages are exchanged via an MMS center wherein the terminals include means for inserting a notification element (ENn) in an MMS message and means for notifying reception of said message on a receiver terminal using the notification element sent with the MMS message.

7. The system according to claim 6, wherein the terminals further include means for adding a notification field to the header of the MMS message and means for detecting the notification field on reception of the message, reception of said MMS message being notified on the receiver terminal by means of the notification element (ENn) as a function of the value of the field added to the header of the message.

8. The system according to claim 6, wherein the MMS center includes means for verifying the capacity of the receiver terminal to notify reception of the message by means of the notification element inserted in the MMS message and means for eliminating the notification element in the MMS message in the event of verification giving a negative result.

9. An MMS client program adapted to be installed in a terminal, the program comprising instructions for composing, sending, and receiving MMS messages, wherein said MMS client program further comprises instructions for inserting a notification element in an MMS message.

10. The program according to claim 9, further comprising instructions for notifying reception of an MMS message on the terminal using the notification element sent with the MMS message.

11. A program according to claim 9, further comprising instructions for automatically adding a notification field in the header (MMS-H) of the MMS message.

12. The program according to claim 11, further comprising instructions for detecting the notification field on reception of an MMS message, reception of said MMS message on the terminal by means of the notification element (ENn) being notified as a function of the value of the field added to the header of the message.

13. A terminal characterized in that it includes an MMS client program according to claim 9.
